(19) United States
(12) Patent Application Publication
(10) Pub. No.: US 2002/0038620 A1
(43) Pub. Date: Apr. 4, 2002

(54) Seed drill opening disk and seed drill using such a disk

(75) Inventor: Guy Gentilhomme, Louisfert (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KUHN-HUARD S.A., CHATEAUBRIANT CEDEX (FR)

(21) Appl. No.: 09/956,013

(22) Filed: Sep. 20, 2001

(30) Foreign Application Priority Data
Sep. 29, 2000 (FR) 00 12400

(51) Int. Cl. A01C 5/00

(52) U.S. Cl. 111/166; 172/604

(57) ABSTRACT

The present invention relates to an opening disk for a seed drill. The opening disk has waves in a manner known to those skilled in the art. These waves allow the disk to work a relatively broad strip of earth. According to one feature of the present invention, the disk advantageously has at least one notch on its circumference. The purpose of the notch(es) is to increase the ability of the disk to penetrate the ground.

### BACKGROUND OF THE INVENTION

1. Field of the Invention

The present invention relates to the general technical field of agricultural machinery. It relates more specifically to an opening disk including at least one wave.

2. Discussion of the Background

A disk such as this is known to those skilled in the art. Specifically, the KUHN-HUARD Semis Direct brochure describes a seed drill including a first series of disks, known as opening disks, intended to prepare lines for sowing. Each opening disk extends in a substantially vertical respective plane. In addition, each opening disk can rotate freely on itself about a substantially horizontal axis substantially perpendicular to a direction of forward travel of said seed drill during work. This known seed drill also includes a second series of disks, known as sowing disks, intended to improve said sowing lines and to seed them.

The circumference of these known opening disks has waves, said waves passing in succession from one side of a vertical mid-plane of said disk to the other. In this known seed drill, the user can advantageously, according to the nature of the ground to be seeded, choose between an opening disk known as a “wavy disk” or an opening disk known as an “embossed disk”. The wavy disk has a relatively low number of waves (about ten) and these have a relatively large amplitude (about 50 mm). This type of disk crumbles the earth well and makes it possible to prepare a relatively broad line for sowing. For its part, the embossed disk has, by comparison with the wavy disk, a greater number of waves, but these are of smaller amplitude. This type of disk is better suited to stony and very hard ground where a good ability of the disk to penetrate the ground is required. The sowing line is worked over a narrower strip.

### SUMMARY OF THE INVENTION

It is an object of the present invention to create an opening disk that allies the two aforementioned advantages, that is to say a disk which has good penetration into the ground and which also causes good crumbling over a relatively great width.

To this end, there is proposed an opening disk including at least one wave, wherein the circumference of said disk has at least one notch. Said notch(es) has (have) the effect of making the disk more aggressive, and therefore of encouraging it to penetrate the ground. Said notch(es) also has (have) a beneficial action on the crumbling of the strip of earth worked.

### BRIEF DESCRIPTION OF THE DRAWINGS

Other features of the invention, to be considered separately or in all possible combinations thereof, will become further apparent from the subclaims and from the following description of one nonlimiting exemplary embodiment of the invention depicted in the appended drawings in which:

FIG. 1 depicts, in perspective, an opening disk according to the invention,

FIG. 2 depicts a plan view of the opening disk of FIG. 1,

FIG. 3 depicts, viewed in the direction of arrow I defined in FIG. 2, the opening disk of FIG. 1.

### DESCRIPTION OF THE PREFERRED EMBODIMENT

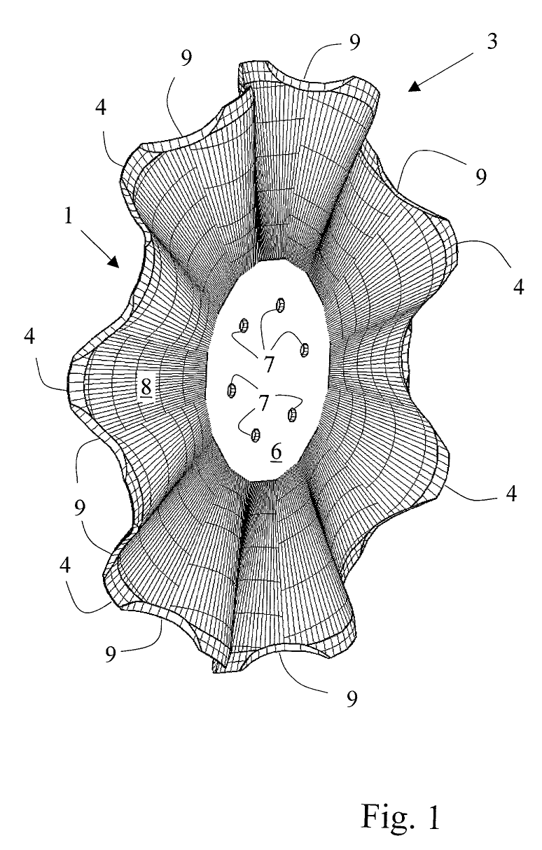

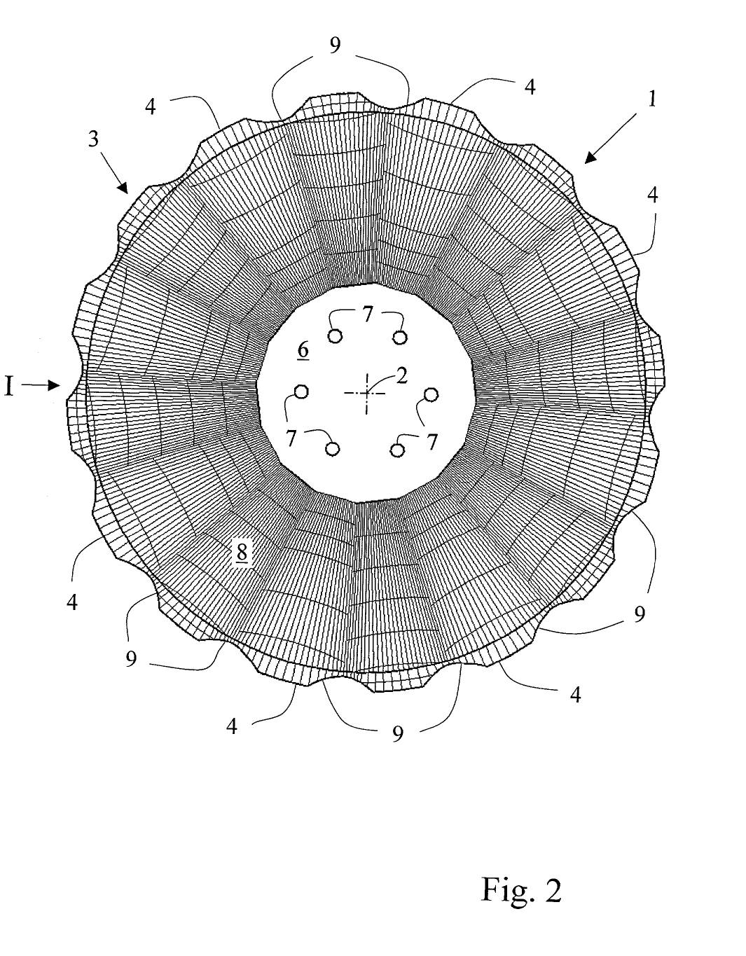

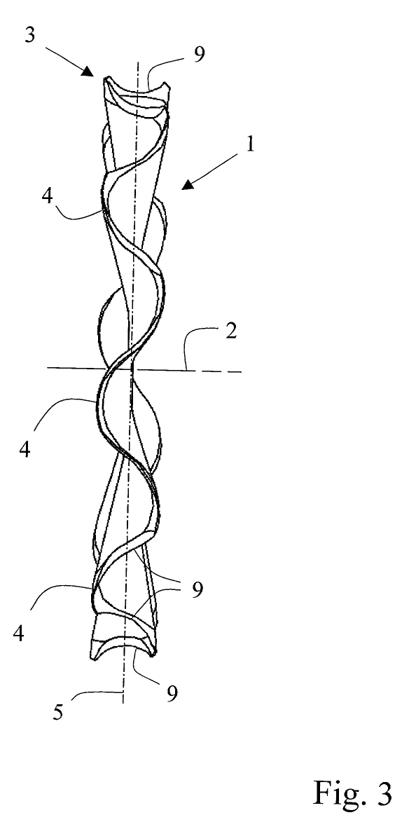

FIG. 1 depicts an opening disk 1 according to the present invention. Said disk 1 is intended to equip a seed drill (not depicted) and to prepare the ground in the sowing line to be seeded. To do this, said disk 1 is connected to said seed drill by means of an articulation (not depicted) of axis 2 (visible in FIGS. 2 and 3). During work, said disk 1 runs along the ground rotating on itself about said axis 2. The circumference 3 of said disk 1 penetrates the ground more or less deeply and thus prepares a line for sowing. In a way known to those skilled in the art, said circumference 3 of said disk 1 is advantageously wavy. The waves 4 allow said disk 1 to work a broader strip of earth than a flat disk would.

In the exemplary embodiment depicted in the figures, said disk 1 has eight waves 4 and, in plan view (FIG. 2), has a substantially circular shape. Said waves 4 are distributed at least substantially uniformly along said circumference 3 of said disk 1. As a preference, said circumference 3 describes a substantially sinusoidal curve, said curve passing successively from one side of a mid-plane 5 (visible in FIG. 3) of said disk 1 to the other. Contrastingly, said disk 1 also has a substantially flat central zone 6 at least substantially lying in said mid-plane 5. Said central zone 6, the shape of which is substantially circular in plan view, is intended to connect said disk 1 to said seed drill. For this purpose, said central zone 6 advantageously has six holes 7 allowing the passage of securing elements (not depicted), such as screws for example. As can be seen more particularly in FIGS. 1 and 2, said disk 1 also has a peripheral zone 8 which provides for a transition between said flat central zone 6 and said sinusoidal circumference 3. In this peripheral transition zone 8, said waves 4 extend substantially radially.

According to an important feature of the present invention, said circumference 3 of said disk 1 has at least one notch 9. Said notch(es) 9 advantageously makes (make) said disk 1 more aggressive. The latter can therefore penetrate the ground more easily, particularly in stony and very hard ground.

In the exemplary embodiment depicted in the figures, said disk 1 has sixteen notches 9 so that each wave 4 is associated with two notches 9. Said notches 9 are advantageously distributed at least substantially uniformly along said circumference 3. More specifically still, said notches 9 are preferably arranged in zones of said circumference 3 where said waves 4 intersect said mid-plane 5. In this way, each wave 4 is associated with one complete notch 9 and two half-notches 9. Said notches 9 advantageously have at least substantially the shape of an arc of a circle.

The opening disk 1 which has just been described is merely one exemplary embodiment which must not in any case be taken to limit the field of protection defined by the claims which follow.

Thus, one might very well envisage a disk 1 having a noncircular, for example elliptical, shape. One might also very well envisage a disk 1 having a different number of waves 4 and/or a different number of notches 9. The same goes for the shape and location of said notches 9 on the circumference 3 of said disk 1.

What is claimed as new and desired to be secured by Letters Patent of the United States is:

1. Opening disk including at least one wave, wherein a circumference of said disk has at least one notch.

2. Opening disk as claimed in claim 1, wherein said circumference passes successively from one side of a mid-plane of said disk to the other.

3. Opening disk as claimed in claim 1, wherein said wave is distributed at least substantially uniformly along said circumference of said disk.

4. Opening disk as claimed in claim 1, wherein said notch is distributed at least substantially uniformly along said circumference of said disk.

5. Opening disk as claimed in claim 1, wherein each wave is associated with two notches.

6. Opening disk as claimed in claim 5, wherein each wave is associated with one complete notch and two half-notches.

7. Opening disk as claimed in claim 3, wherein said circumference passes successively from one side of a mid-plane to said disk to the other wherein said notch is arranged in one zone of said circumference where said wave intersects said mid-plane.

8. Opening disk as claimed in claim 1, wherein said notch has at least substantially the shape of an arc of a circle.

9. Opening disk as claimed in claim 1, wherein said disk, viewed in plan view, has an at least substantially circular shape.

10. Opening disk as claimed in claim 1, wherein said wave extends substantially radially.

11. Opening disk as claimed in claim 1, wherein said disk additionally includes an at least substantially flat central zone.

12. Opening disk as claimed in claim 11, wherein said central zone has at least one securing hole.

13. Seed drill including at least one opening disk as claimed in claim 1.
